(19) United States
(12) Patent Application Publication
(10) Pub. No.: US 2020/0106191 A1
(43) Pub. Date: Apr. 2, 2020

(54) ANTENNA ELEMENT AND ANTENNA ARRAY

(71) Applicant: Nidec Corporation, Kyoto (JP)

(72) Inventor: Takumi YAMAGUCHI, Kyoto (JP)

(21) Appl. No.: 16/585,115

(22) Filed: Sep. 27, 2019

(30) Foreign Application Priority Data
Sep. 28, 2018 (JP) 2018-183132
Sep. 20, 2019 (JP) 2019-170956

(51) Int. Cl. H01Q 21/06; H01Q 21/00; G01S 7/03

(52) U.S. Cl. CPC H01Q 21/064; G01S 7/2813; G01S 7/03; H01Q 21/0087

(57) ABSTRACT

An antenna element manufacturing method includes forming a hollow by combining at least two molds movable relative to each other, injecting a material into the hollow to produce a molded article, and separating the molded article from the molds by pushing a first kind of reception surface provided at a specific site of the molded article using an ejector pin. The antenna element includes a conductor including a conductive surface, an at least partially conductive first protrusion, and a conductive second protrusion. The conductor includes at least one first slot opening on the conductive surface, a center portion of the first slot extending in a first direction along the conductive surface, and the first protrusion and the second protrusion are aligned in a second direction which intersects the first direction and is located along the conductive surface.

### CROSS REFERENCE TO RELATED APPLICATION

The present application claims priority under 35 U.S.C. § 119 to Japanese Application No. 2018-183132 filed on Sep. 28, 2018 and Japanese Application No. 2019-170956 filed on Sep. 20, 2019, the entire contents of which are hereby incorporated herein by reference.

### 1. FIELD OF THE INVENTION

The present disclosure relates to an antenna element and an antenna array.

### 2. BACKGROUND

U.S. Patent Publication No. 2017/0194716 discloses an antenna array in which horn antennas are used as individual antenna elements. A horn antenna has preferable characteristics such as capability of emitting and receiving electromagnetic waves in a relatively wide frequency band. Nevertheless, in order to obtain such preferable characteristics, the opening of the horn antenna needs to be made large to some extent. Therefore, it is difficult in an antenna array in which a plurality of horn antenna elements are arranged to shorten arrangement intervals of the horns. Meanwhile, large arrangement intervals of the antenna elements result in largely spoiling performance of the antenna array caused by grating lobes arising in an emission pattern of the antenna array in diagonally frontward directions.

### SUMMARY

Example embodiments of the present disclosure provide antenna elements that are each capable of being be provided in an antenna array and suppresses grating lobes in a frontward direction while securing frequency characteristics of the antenna array, and which can be produced on a mass scale.

An example embodiment of the present disclosure provides an antenna element manufacturing method in which a hollow is formed by combining at least two molds movable relative to each other, a material in a fluid state is injected into the hollow and solidified to produce a molded article, and the molded article is separated from the molds by pushing at least one reception surface provided at a specific site of the molded article using an ejector pin in the mold. The antenna element includes a block-shaped or plate-shaped conductor including a conductive surface and an at least partially conductive first protrusion and a conductive second protrusion connected to the conductive surface and extending in a direction away from the conductive surface. The conductor includes at least one first slot opening on the conductive surface, a center portion of the first slot extending in a first direction along the conductive surface, the first protrusion and the second protrusion are aligned in a second direction which intersects the first direction and is along the conductive surface. Furthermore, in the antenna element, when the conductive surface is seen in plan view, the center portion is at a position interposed between the first protrusion and the second protrusion, a distance between a center of the first protrusion and an edge of an opening of the first slot at the center portion is smaller than a distance between a tip surface of the first protrusion and the conductive surface. A distance between a center of the second protrusion and an edge of the first slot opening at the center portion is smaller than a distance between a tip surface of the second protrusion and the conductive surface. At least one first kind of reception surface which is included in the at least one reception surface is provided on at least one of the tip surfaces of the first protrusion and the second protrusion.

According to example embodiments of the present disclosure, antenna elements each achieve a wide frequency band used in transmission/reception and can be produced on a mass scale.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a plan view of an antenna array 100 according to an example embodiment of the present disclosure.

FIG. 2 is a magnified plan view including a portion of the antenna array shown in FIG. 1.

FIG. 3 is a cross-sectional view taken along the A-A line in FIG. 1.

FIG. 4 is a partially magnified perspective view of a protrusion 113 according to an example embodiment of the present disclosure.

FIG. 5 is a partially magnified perspective view of the protrusion 113 including a modified reception surface Ea.

FIG. 6 is a partial cross-sectional view exemplarily showing a mold MB used in molding the antenna array according to an example embodiment of the present disclosure.

FIG. 7 is a perspective view showing a modification of an antenna array according to an example embodiment of the present disclosure.

### DETAILED DESCRIPTION

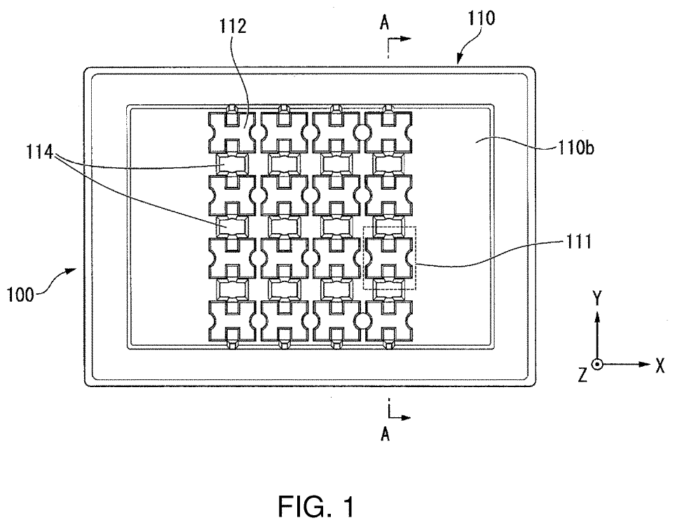

FIG. 1 is a plan view of an antenna array 100 according to an example embodiment of the present disclosure. Hereinafter, the drawings properly show an XYZ-coordinate system as the three-dimensional Cartesian coordinate system. The antenna array 100 includes a plurality of antenna elements 111. The portion enclosed by the dotted line in FIG. 1 corresponds to one antenna element 111. In the XYZ-coordinate system, the X-axis direction (first direction) and the Y-axis direction are directions which are perpendicular to each other and in which the antenna elements 111 are arranged in an array. The Z-axis direction is the direction perpendicular to both the X-axis direction and the Y-axis direction. Moreover, to state a plan view denotes that it is a view as seen from the Z-direction. Hereinafter, a configuration of the antenna array is described using the XYZ-coordinates.

The antenna array 100 in the present example embodiment is configured by providing a plurality of slots 112 in a conductor 110 including a conductive surface 110b. In this example, the conductor 110 has a plate shape. Alternatively, other than a plate shape, a shape, such as a block shape, which is thicker than the plate shape can also be selected if so desired. The plurality of slots 112 penetrate the conductor 110 in the Z-direction. The plurality of slots 112 are two-dimensionally arranged along the X-direction and the Y-direction. In the present example embodiment, 16 slots 112 are preferably arranged into four columns and four rows. The number and the arrangement of slots 112 may differ from those in the shown example embodiment. For example, a plurality of slots 112 may be one-dimensionally arranged if so desired.

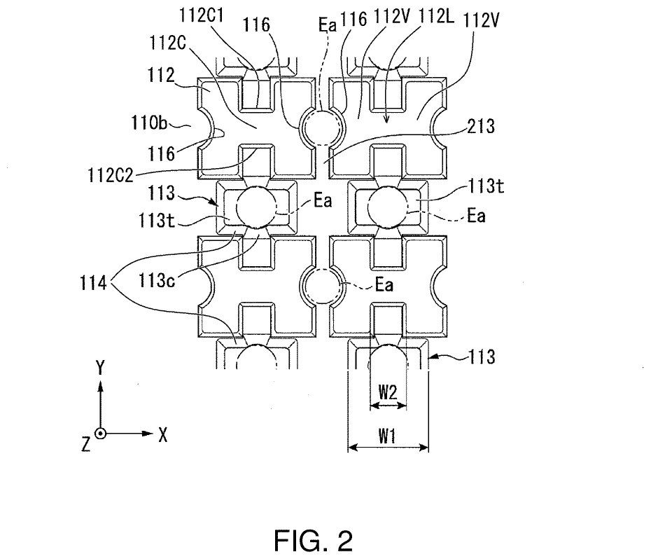

FIG. 2 is a partially magnified view of FIG. 1. Each slot 112 preferably has a shape similar to an alphabet “H” as seen from the Z-direction. The slot 112 in such a shape is occasionally called an “H-shaped slot”. More specifically, the slot 112 has a shape in which its center portion extends in the first direction (X-direction in the present example embodiment). This portion is hereinafter called a traverse portion 112L. Moreover, each slot 112 preferably includes a pair of portions which extend in a direction different from the first direction and are connected by the center portion. These portions are hereinafter called vertical portions 112V. Namely, each slot 112 includes the traverse portion 112L extending in the first direction, the vertical portions 112V extending along a second direction intersecting the first direction. In this example embodiment, the slot 112 includes the vertical portions 112V respectively at both end portions of the traverse portion 112L. Moreover, the second direction coincides with the Y-direction. However, there can also be used, depending on a desired purpose, a slot having a shape in which the vertical portions 112V extend in a direction different from the Y-direction. The shape of the slot 112 may be other than the H-shape as long as the center portion thereof at least has a shape extending in the first direction. An I-shape without vertical portions, a U-shape, or the like can be used.

The antenna array 100 preferably includes each protrusion 113 positioned between slots 112 adjacent in the Y-direction on the conductive surface 110b. Each protrusion 113 is connected to the conductive surface 110b at its proximal end, and extends in the direction away from the conductive surface (+Z-direction). The protrusion 113 has conductivity at least on its surface. The protrusions 113 are preferably adjacent to the edges of the openings of the slots 112, and protrude from the conductive surface 110b. The center portion of at least one of the plurality of slots 112 is interposed between two protrusions 113. These two protrusions 113 are aligned in a direction intersecting the first direction. In this example, such two protrusions 113 are aligned in the Y-direction. But the alignment of these two protrusions 113 is not limited to this specific arrangement, and any other desirable arrangement may be used. Moreover, the direction in which the two protrusions 113 are aligned may differ from the second direction. In this example, the second direction preferably forms an angle of about 90 degrees relative to the first direction, but is not limited to forming this angle. For example, the angle may be about 60 degrees, or any other desirable angle, depending on the configuration of the antenna array.

Two protrusions 113 which are aligned with a slot 112 being interposed therebetween are hereinafter occasionally called a protrusion pair 114. Lateral surfaces, of the individual protrusions 113 defining the protrusion pair 114, which are oriented in the Y-direction face each other. A combination of the protrusion pair 114 and the slot 112 defines and functions as one antenna element 111. Therefore, the combination of the two protrusions 113 and the slot 112 is hereinafter properly called a “protrusion-equipped antenna element”, or simply, an “antenna element”.

As the opening of the slot 112 is seen in plan view, an edge 112C1 of a center portion 112C in the +Y-direction (on one side in the second direction) is adjacent to the protrusion 113 that is positioned on the +Y-direction side. Likewise, an edge 112C2 of the center portion 112C in the −Y-direction (on the other side in the second direction) is adjacent to the protrusion 113 that is positioned on the −Y-direction side. Focusing on one slot 112, in this example, the edges 112C1 and 112C2 are positioned on the sides closer to the center of the slot 112 than the respective protrusions 113 adjacent to them. Moreover, the distance from the center of the protrusion 113 to the center of the adjacent slot 112 is smaller than the distance between a tip surface 113t of the protrusion and the conductive surface 110b. Namely, a structure in which adjacent two protrusions 113 are closely arranged in the Y-direction is included. In this example, a width W2 of the traverse portion 112L in the first direction (direction in which the center portion of the slot 112 extends and which is herein the X-direction) is preferably smaller than a width W1 of each protrusion 113 defining the protrusion pair 114 in the same first direction. By giving such alteration to the widths of the traverse portion 112L and the protrusion 113, characteristics of the individual antenna elements can be adjusted.

In the example shown in FIG. 2, the edges of the vertical portions 112V of the slots 112 preferably include swelling portions 116 swelling toward the traverse portions 112L. Such slots 112 are aligned in the X-direction (first direction). In this example, a wall 213 between adjacent two vertical portions preferably includes two swelling portions 116 swelling in reverse directions to each other. Convexities and concavities inside a slot largely affect performance thereof as an antenna element. Also, when the swelling portions 116 are provided on the vertical portions 112V, characteristics of the slots 112 as the antenna elements are caused to change. Nevertheless, large deterioration in the performance is able to be prevented by adjusting the dimensions of the other portions in the slots 112 and the detailed shapes of the protrusions 113.

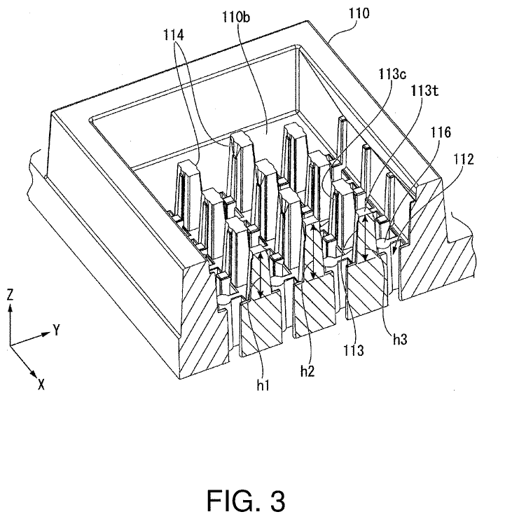

FIG. 3 is a perspective view of the conductor 110, and also shows a cross section taken along the A-A line in FIG. 1. A height h2 of the center protrusion 113 out of the three protrusions 113 which are aligned along the cross section is preferably larger than heights h1 and h3 of the protrusions 113 which are positioned to be adjacent to that. Moreover, in this example, h1 and h3 are equal to each other. While in this example, the height h1 and the height h3 are equal to each other, they may be different. As above, by selecting the heights of the protrusions 113, the directivity of the antenna array is able to be adjusted. Notably, the height of the protrusion 113 is the distance between the edge of the opening of the slot 112 and the tip surface 113t of the protrusion 113. When the edge of the opening of the slot 112 is on the conductive surface 110b, the height of the protrusion 113 is also the distance between the tip surface 113t of the protrusion 113 and the conductive surface 110b.

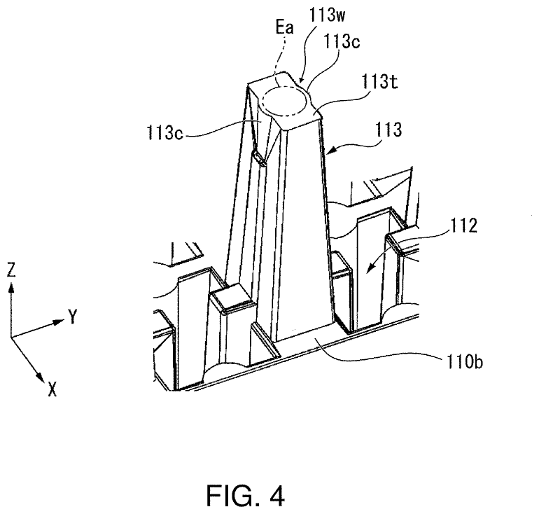

FIG. 4 is an expanded view of the protrusion 113. Bulges 113c are present on lateral surfaces that are positioned on the sides of the slots 112 out of the lateral surfaces of the protrusion 113. The bulges 113c on those lateral surfaces of the protrusion 113 swell toward the slots 112, and extend in the height direction of the protrusion 113 (Z-direction). Moreover, one end of each bulge 113c reaches the tip surface 113t. In this example, the bulges 113c are preferably provided on both lateral surfaces of the two protrusions 113 (protrusion pair 114) which are adjacent across the slot 112 (see FIG. 3). The configuration as above can improve performance of the antenna element including the slot 112 and the pair of protrusions 113. It should be noted that the bulge 113c may be provided on only one lateral surface as needed. The width, of the tip surface 113t, measured in the second direction is locally enlarged at the portion where the bulges 113c reach the tip surface 113t. A reception surface Ea mentioned later is able to be provided at this portion where the width of the tip surface 113t is locally enlarged. This portion may be referred to as a wider portion 113w in the present specification. The entire portion of one reception surface Ea does not have to be accommodated in one wider portion 113w. At least portion of the reception surface Ea may be arranged in the wider portion 113w.

An antenna element and an antenna array 100 of example embodiments of the present disclosure are preferably produced by die casting or other methods which use molds, for example. In such methods, a hollow is formed by combining at least two molds movable relative to each other, a material in a fluid state is injected into the hollow and solidified to produce a molded article, and the molded article is separated from the molds by pushing at a specific site of the molded article using an ejector pin in the mold. The site on the surface of the molded article on which the tip of the ejector pin touches is called a “reception surface” in the present specification because the site receives a force from the ejector pin. An area of the inner surface of the cavity where the ejector pin is arranged is accompanied by a minute discontinuation. The discontinuation often results in a mark on the surface of the molded article.

Performance of the slot 112 as an antenna is largely improved by the protrusions 113 located on both sides of the slot 112. The pair of protrusions 113 and the slot 112 between those can also be regarded collectively as one antenna element. In this case, two antenna elements adjacent in the second direction (Y-direction) preferably share one protrusion 113 positioned between those. In general, the shape of the protrusion 113 largely affects characteristics of the antenna element. Nevertheless, a reception surface arranged on the tip surface 113t does not greatly affect the characteristics of the antenna element in any of the case of being concave and the case of being convex. Therefore, when a reception surface is needed on the tip surface 113t, it can be arranged relatively flexibly. Notably, as the reception surface Ea, a shape protruding from its periphery can be selected. Its influence on the characteristics of the antenna element is very small as long as the difference in height between the reception surface Ea and the periphery is smaller than the maximum value of the projection amounts of the bulges 113c, in any of the case where the reception surface Ea is caused to be concave and the case where it is caused to protrude. Notably, in this case, the magnitudes of swells of the bulges 113c are at their maximums at the portions where the bulges 113c are connected to the tip surface 113t.

As shown in FIG. 2, the reception surface Ea is also able to be provided on the wall 213 positioned between the vertical portions 112V, of the slots 112, which are adjacent in the X-direction. The reception surface Ea on the wall 213 is hereinafter called a second kind of reception surface to distinguish it from the reception surface Ea that is arranged at the tip of the protrusion 113. The reception surface at the tip of the protrusion 113 is hereinafter occasionally called a first kind of reception surface.

In the example shown in FIG. 2, the wall 213 between the two vertical portions 112V adjacent in the X-direction preferably includes two swelling portions 116 that swell in reverse directions to each other. The width of the wall 213 is preferably locally enlarged between these two swelling portions 116. The second kind of reception surface Ea is provided at this portion. In the arrangement of this example, if the center portion 112L of the slot 112 is virtually extended along the first direction (X-direction), the extended one crosses this portion. But other arrangements of the portion can be selected. The reception surfaces Ea are arranged in the vicinities of the slot 112, and thus, the molded article at sites close to the slot 112 is able to be more reliably separated.

Using the antenna elements including the H-shaped slots 112 shortens arrangement intervals of the antenna elements, particularly, in the X-direction. In the present example embodiment, the arrangement intervals of the antenna elements of the antenna array 100 in the X-direction are preferably about 0.59λo, for example. The arrangement intervals of the antenna elements thereof in the Y-direction are preferably about 0.69λo, for example. Herein, λo is the free-space wavelength at the center frequency of a frequency band transmitted or received. Moreover, the protrusions 113 are preferably adjacent to the center portion of the slot 112, extending in the first direction, and thus, a frequency range of electromagnetic waves which the antenna elements can transmit or receive is able to be expanded. As described above, since the arrangement intervals between the antenna elements are smaller than λo, grating lobes are reduced or eliminated, in the X-direction, on the antenna array 100 including these plurality of antenna elements.

The aforementioned antenna array 100 can be manufactured, for example, by filling the inside of one or more molds with a material in a fluid state where they are combined, and after that, solidifying the material.

As the material in a fluid state, molten metal, metal in a semi-solid state, resin in a fluid state, a material of thermosetting resin before being cured, metal powder having fluidity by being mixed with binder, or the like can preferably be used.

As a method of filling the inside of the mold(s) with the aforementioned fluid material, a die casting method, an injection molding method, which are performed by injection under pressure, or the similar method can be used. The material of the mold(s) is preferably hot work tool steel with durability for mass production, for example, but is not limited to this.

The mold(s) most typically have a configuration in which two or three or more molds are combined to define an inner hollow, which enables the material to be injected therein. Then, after the injected material is solidified, the molds are separated to take out a molded article.

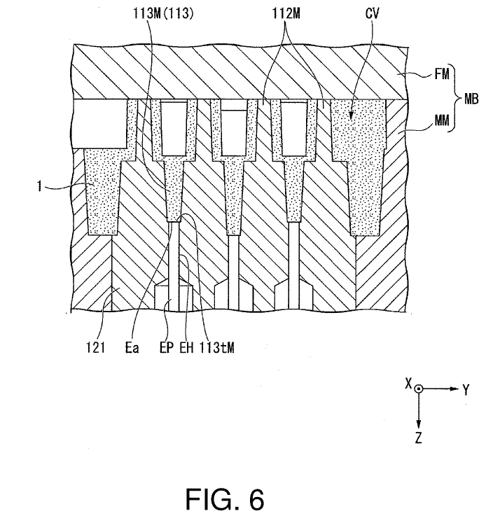

FIG. 6 is a partial cross-sectional view exemplarily showing a mold MB used in molding the antenna array 100. Under the condition that this partial cross section is drawn in the state where a cavity CV is filled with the solidified material, the surface obtained by cutting the solidified material is a cross section taken along the A-A line in FIG. 1.

The mold MB preferably includes a fixed mold FM and a movable mold MM. Generally, the mold MB includes at least two molds.

However, three or more molds may be used if so desired. FIG. 6 shows the XYZ-coordinate system which is same as the one used for describing the antenna array 100 obtained from the molded article 1. Combining the fixed mold FM and the movable mold MM defines the cavity CV which is the inner hollow. Typically, the inner hollow is formed by moving the movable mold MM in the −Z-direction, and the movable mold MM is separated from the fixed mold FM by being moved in the +Z-direction. It should be noted that another movement may be performed as needed. Notably, the shape of the molded article 1 coincides with the shape of the antenna array 100 within margins of errors of illustration. Therefore, the term “molded article 1” and “antenna array 100” are hereinafter used interchangeably.

The movable mold MM in the present example embodiment preferably includes an insert 121. The insert 121 includes a plurality of pillars 112M, the tips of which are in contact with the fixed mold FM in the state where the fixed mold FM and the movable mold MM are combined. The circumferential surfaces of the pillars 112M define the inner circumferential surfaces of the slots 112. The insert 121 includes a plurality of third recess portions 113M each of which extends between any adjacent two pillars 112M in the Z-direction. The third recess portions 113M define the protrusions 113 in the antenna array 100. The insert 121 includes the pillars 112M, and they are located between the third recess portions 113M which are aligned in the Y-direction. The bottoms of the third recess portions 113M include bottom surfaces 113tM that define the tip surfaces of the protrusions 113.

Through holes EH open on any one or more of the plurality of bottom surfaces 113tM. The through holes EH penetrate the insert 121 in the Z-direction. The through holes EH house ejector pins EP. The outer diameter of the ejector pin EP is slightly smaller than the inner diameter of the through hole EH. The term “slightly” in this case means that such a small dimensional difference arises which realizes a state where the ejector pin EP can move without sticking to the inside of the through hole EH and the material in a fluid state which is injected into the cavity CV and leak through the through hole EH is small in an amount to provide sufficient manufacturing tolerances for the antenna array 100. Such a dimensional relation makes the ejector pin EP movable relative to the insert 121 in the Z-direction. The tip of the ejector pin EP is positioned on the bottom surface 113tM of the third recess portion 113M, and as a result, the reception surface Ea (first kind of reception surface) is positioned at the tip portion of the protrusion 113 of the molded article 1. Notably, a description of a fine structure of the shape of the cavity CV of the mold MB is supposed to have been described by the description of the shape of the molded article 1 (antenna array 100). A manufacturing method of the antenna array 100 according to an example embodiment of the present disclosure supposes that, after the cavity CV is filled with the material in a fluid state without gaps, solidification is occurred with the shape in filling state maintained. In this state, the description of the fine shape of the molded article 1 is thought to satisfactory reflects the fine structure of the shape of the cavity CV. Notably, the state of “with the shape in filling state maintained” is herein regarded as including slight changes in shapes due to shrinkage, sink marks, warps and the like in solidification.

A procedure of manufacturing the antenna array 100 according to an example embodiment of the present invention using the aforementioned mold MB is described.

When the material is a metal material, a manufacturing method of the antenna array 100 preferably includes: a step of preparing the mold MB; a molding step of injecting the material in a fluid state the mold MB and solidifying it to mold the molded article 1; a mold releasing step of releasing the molded article 1 from the mold MB; and a post-step of removing gates, overflows, burrs, and the like from the molded article 1.

When the material is a resin material, the completed antenna array 100 includes the molded article 1 having undergone injection molding, and a conductive layer covering at least a portion of the surface of the molded article 1. When the material in the state of fluidity is a resin material, a manufacturing method of the antenna array 100 includes: a molding step of injecting the material in a fluid state into the mold MB and solidifying it to mold the molded article 1; a mold releasing step of releasing the molded article 1 from the mold MB after the molding step; a post-molding step of removing runners, gates, burrs, and the like from the molded article 1; and a coating step of coating at least a portion of the surface of the molded article 1 with the conductive layer preferably using, for example, plating processing. A region which is coated with the conductive layer in the coating step includes the inner circumferential surfaces of the slots 112, the conductive surface 110b, and the surfaces of the protrusions 113.

In the molding step, the material in a fluid state is injected into the inside of the mold MB. After the material is solidified inside the mold MB and molded as the molded article 1, the movable mold MM is moved in the direction away from the fixed mold FM. The movement of the movable mold MM separates the fixed mold FM and the movable mold MM from each other to end the molding step. Subsequently, the ejecting step is performed.

In the ejecting step, the ejector pins EP are driven relative to the movable mold MM in the −Z-direction. The ejector pins EP being driven in the −Z-direction push the reception surfaces Ea (first kind of reception surfaces) of the protrusions 113 on the molded article 1 sticking onto the movable mold MM toward the −Z-direction. The molded article 1 the reception surfaces Ea of which are pushed by the ejector pins EP is separated from the movable mold MM. Notably, the mold releasing step can also be simultaneously performed when the fixed mold FM and the movable mold MM are separated from each other.

In the present example embodiment, the molded antenna array 100 preferably includes the bulges 113c on the lateral surfaces of the protrusions 113. Therefore, the widths of the tip surfaces 113t (widths thereof in the Y-direction) are locally enlarged in portions where the bulges 113c cross the tip surfaces 113t of the protrusions 113. By arranging the reception surfaces Ea in these portions enlarged in width, the areas of the individual reception surfaces Ea are able to be made to be larger. Therefore, the ejector pins EP with larger diameters can be used to drive with stronger force without the tip surfaces 113t being damaged. While the molded article 1 in the present example embodiment has a large resistance at the ejection, since it includes the plurality of protrusions 113, such capability of driving the ejector pins EP with stronger force makes ejecting the molded article 1 from the mold (movable mold MM) easier. Notably, the bulges 113c are not necessarily needed. A structure without bulges can also be selected if needed to achieve specific performance capabilities of the antenna array 100, or for any other desirable reasons.

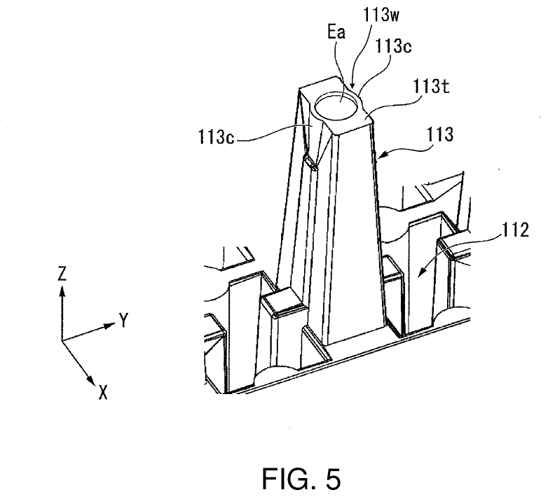

As shown in FIG. 4 and FIG. 5, in these examples, the protrusion 113 preferably includes the flat tip surface 113t. It should be noted that it may be a curved surface. Setting the tip surface 113t to be a flat surface makes production of the mold MB easier. While in the present example embodiment, the reception surface Ea is circular as seen from the Z-direction, the shape of the reception surface Ea is not limited to a circle in the disclosure of the present application. For example, the shape of the reception surface Ea may be a rhombus, an ellipse, etc. Otherwise, a dumbbell-shaped reception surface Ea in which two circles are connected may be also be used. In the state where the conductive surface 110b is seen in plan view (state of looking down along the Z-direction), the reception surface Ea is positioned on a flat surface, and the center of gravity of the flat surface is positioned inside the reception surface Ea.

Since the centers of gravity of the tip surfaces 113t are positioned inside the reception surfaces Ea, the ejector pins EP push the centers of gravity of the tip surfaces 113t in the mold releasing step. Therefore, in the manufacturing method of the present example embodiment, the antenna array 100 is able to be more reliably ejected from the mold.

As shown in FIG. 2, the reception surfaces Ea (second kind of reception surfaces) are also able to be arranged on the walls 213 each of which is positioned between the vertical portions 112V, of the slots 112, which are adjacent in the X-direction. Addition of the reception surfaces Ea on these portions enables the antenna array 100 to be more smoothly ejected from the mold. In this example, the shape of the second kind of reception surfaces is a circle. Nevertheless, similarly to the first kind of reception surfaces, various shapes can be selected for the second kind of reception surfaces.

FIG. 5 is a partially magnified perspective view having the protrusion 113 including the reception surface Ea of the modification.

When the tips of the ejector pins EP protrude from surfaces used in molding the peripheries of the reception surfaces Ea in the movable mold MM, the reception surfaces Ea positioned on the tip surfaces 113t of the molded protrusions 113 become concave from the peripheries.

As shown in FIG. 4 and FIG. 5, in the antenna array 100 according to the manufacturing method of the present example embodiment, the protrusions 113 are preferably adjacent to the slots 112. To be more exact, in the state where the conductive surface 110b is seen in plan view, the distance between the proximal end of the protrusion 113 at which the protrusion 113 is connected to the conductive surface 110b and the edge of the opening of the slot 112 at the center portion is preferably smaller than the distance between the tip surface 113t of the protrusion 113 and the conductive surface 110b. As apparent from FIG. 1 and FIG. 3, one slot 112 is along with the protrusion 113 (first protrusion) positioned on the +Y-side, and the protrusion 113 (second protrusion) positioned on the −Y-side. Namely, the center portion of the slot 112 extends in the X-direction (first direction), and the center portion thereof is interposed between the two protrusions 113 which are aligned in the Y-direction (second direction). Furthermore, as to each of the two protrusions 113, the distance between its proximal end and the edge of the opening of the slot 112 at the center portion is smaller than the distance between the tip surface 113t of the protrusion 113 and the conductive surface 110b. Such arrangement can realize the antenna element which is small in dimension in an E-plane direction (mentioned later). Furthermore, the antenna array 100 including the plurality of antenna elements as above is able to reduce or prevent grating lobes in the Y-direction (E-plane direction) by shortening arrangement intervals of the antenna elements in the E-plane direction.

Nevertheless, the arrangement described above results in allowing concentrated arrangement, within a narrow region, of surfaces expanding to be long in the lengthwise direction (Z-direction) which surfaces are the inner circumferential surfaces of the slots 112 and the circumferential surfaces of the protrusions 113. Since this “lengthwise direction” is the direction in which the mold moves in the mold releasing step, the antenna array 100 suffers large resistance in the peripheries of the protrusions 113 in mold releasing, and there is even a possibility that the molded article breaks in some cases.

With the manufacturing method of the present example embodiment, such incidents or obstacles in the ejecting step are able to be reduced or prevented, by using the configuration in which the reception surfaces Ea are provided on the tip surfaces 113t of the protrusions 113, which are in the vicinities of the regions in which the surfaces expanding to be long in the Z-direction concentrate, and they are pushed by the pins EP. While the reception surfaces Ea are preferably provided respectively on both tip surfaces 113t of the first protrusion 113 and the second protrusion 113, the preferable effect can be obtained even when arranging the reception surfaces Ea on one of the first protrusion 113 and the second protrusion 113.

Notably, as the material used in molding the antenna array 100 of the present application, any of resin and metal can preferably be used. Any material can be basically used as long as the material has a property that it is in a flowable state when being injected into the inside of the cavity CV, and after that, its fluidity is lost in the mold and solidified. Specifically, aluminum, magnesium, zinc, or any of alloys with these elements being as main components as defined by the industrial standards such as ISO or ANSI, for example, can be preferably used as the material. Moreover, techniques of injecting metal in the state of semiliquid into a mold, such as, for example, rheocasting, thixomolding, etc., can also preferably be used.

As the resin, thermoplastic resin or thermosetting resin can preferably be used. It should be noted that when the resin is selected as the material, conductivity needs to be furnished to its surface in the post-step. As a method of giving the conductivity, while physical vapor deposition can be used, plating processing is preferably selected with productivity being taken into consideration. Therefore, some kinds of resin materials that are excellent in plating properties are more preferably used. More specifically, engineering plastics such as, for example, polycarbonate resin, polycarbonate/acrylonitrile butadiene styrene (PC/ABS), and syndiotactic polystyrene resin (SPS resin) can preferably be used. Otherwise, thermosetting resin such as phenol resin, for example, may be used.

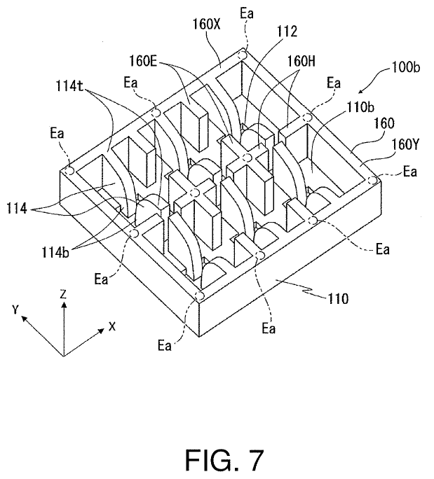

FIG. 7 is a perspective view showing a modification of the antenna array 100. In this figure, the same elements as those in FIG. 1 to FIG. 5 described in the aforementioned example embodiment are given the same signs and their description is omitted.

As shown in FIG. 7, an antenna array of the present modification includes the wider sweep of the individual protrusions 113 in the Y-direction (E-plane direction) than the antenna array 100 described with FIG. 1 to FIG. 5. Therefore, the modes of the protrusions 113 somewhat resemble walls. They are, however, hereafter still called protrusions to differentiate them from an outer wall 160 and the like. The dimension of the gap between the members of the protrusion pair 114 (that is, the distance between the two protrusions 113 facing each other across the slot 112 in the Y-direction) is preferably monotonously increasing as going from proximal ends 114b of the protrusion pair 114 to top 114t. In the antenna array of the present modification, six antenna elements are preferably arranged in the X-direction and the Y-direction to define a two-dimensional matrix. The six antenna elements are enclosed by the outer wall 160 which is conductive. The outer wall 160 includes a pair of first portions 160X extending in the X-direction, and a pair of second portions 160Y extending in the Y-direction, and is rectangular as seen from the Z-direction. Namely, the outer wall 160 is preferably a continuous wall.

A plurality of conductive inner walls that partition adjacent antenna elements are preferably arranged inside this outer wall 160. These inner walls include a plurality of inner walls 160E extending in the E-plane direction (Y-direction in the present example embodiment), and a plurality of inner walls 160H extending in an H-plane direction (X-direction in the present example embodiment). Each of these inner walls 160E and 160H is not continuous at its center portion but is instead discontinuous.

In the present specification, the “E-plane” is a plane which is perpendicular to the conductive surface 110b and includes a direction of going from one protrusion of the pair of protrusions 114 toward the other protrusion. Moreover, the “H-plane” is a plane which is perpendicular to the conductive surface 110b and includes a direction in which the traverse portion 112L of the H-shaped slot extends (the X-direction or the first direction). An antenna array and antenna elements defining the array most efficiently receive electromagnetic waves out of incident electromagnetic waves the vectors of electric fields of which are parallel to the E-plane and the vectors of magnetic fields of which are parallel to the H-plane. Therefore, the planes are called the E-plane and the H-plane, respectively. The direction parallel or substantially parallel to the H-plane is the “H-plane direction”, and the direction parallel or substantially parallel to the E-plane is the “E-plane direction” as seen from the direction perpendicular or substantially perpendicular to the conductive surface 110b (Z-direction). In the present modification, the H-plane direction coincides with the X-direction, and the E-plane direction coincides with the Y-direction.

Each of the outer wall 160 and the inner walls 160E and 160H is a wall or a protrusion extending from the conductive surface 110b in the Z-direction. The inner walls 160E extend in the Y-direction as seen in the Z-direction. The inner walls 160H extend in the X-direction as seen in the Z-direction. Namely, the walls or the protrusions included in the antenna array 100b in the present modification preferably include first portions 160E and 160Y extending in the Y-direction, and second portions 160H and 160X extending in the X-direction. The reception surfaces Ea which receive the ejector pins EP are preferably arranged at portions where the first portions 160E intersect the second portions 160H or 160X, portions where the first portions 160Y intersect the second portions 160H or 160X, or portions where the protrusions 113 intersect the second portions 160X. Notably, in the example of FIG. 7, the protrusions 113 are not connected to the second portions 160H. In still another modification, there can be however used a structure in which the protrusions 113 are connected to the second portions 160H. In such a case, the reception surfaces Ea can be arranged also at portions where the protrusions 113 intersect the second portions 160H. Notably, these reception surfaces Ea are more preferably arranged on upper end surfaces of the outer wall 160 and the inner walls 160E and 160H (end portions on the Z-direction side).

In the mold releasing (ejecting step) step, the portions where the first portions 160E, 160X intersect the second portions 160H, 160Y, which are perpendicular or substantially perpendicular to one another, are held on the movable mold MM with strong force. In the present modification, the molded article 1 can be effectively released from the mold by pushing the portions held on the movable mold MM with strong force with the ejector pins EP in the mold releasing step.

As above, some example embodiments according to the present disclosure have been described with reference to the appended drawings, the present disclosure is not limited to such examples. The various shapes, combinations and the like of elements shown in the aforementioned examples are merely exemplary, and various modifications and alterations can occur based on design requirements and the like without departing from the scope and spirit of the present disclosure.

The antenna elements or the antenna arrays of example embodiments of the present disclosure can be preferably used in radar apparatuses or radar systems mounted on movable bodies, for example, as a vehicle, a ship, an airplane, a robot and the like. The radar apparatus includes the antenna array in any of the aforementioned example embodiments, and a microwave integrated circuit such as an MMIC, for example, connected to the antenna array. The radar system preferably includes the radar apparatus, and a signal processing circuit connected to the microwave integrated circuit of the radar apparatus. The signal processing circuit performs processing, for example, of estimating the orientation of incoming waves on the basis of signals received by the microwave integrated circuit and the similar processing. The signal processing circuit can be configured to estimate the orientation of incoming waves and to output a signal indicating the estimation result by executing any of algorithms, for example, as a MUSIC method, an ESPRIT method, and a SAGE method. The signal processing circuit may be further configured to estimate the distance to a target which is the source of the incoming waves, the relative speed of the target, and the orientation to the target by a known algorithm.

The term “signal processing circuit” in the present disclosure is not limited to denoting a single circuit but also includes a mode in which a combination of a plurality of circuits is conceptually regarded as one functional component. The signal processing circuit may be realized by one or a plurality of systems on chip (SoCs). For example, a portion or all of the signal processing circuit may be a field-programmable gate array (FPGA), which is a programmable logic device (PLD). In this case, the signal processing circuit includes a plurality of calculating elements (for example, general-purpose logics and multipliers), and a plurality of memory elements (for example, lookup tables or memory blocks). Otherwise, the signal processing circuit may be an aggregate of a general-purpose processor and a main memory device. The signal processing circuit may be a circuit including processor cores and a memory. These elements described above can define and function as signal processing circuits.

The antenna arrays of the example embodiments of the present disclosure can more significantly reduce the area of the surface on which antenna elements are arranged compared to a conventional configuration. Therefore, the radar system which this antenna array is implemented on can be easily mounted, for example, on a narrow place of a vehicle including the surface opposite to a mirror surface of a rear view mirror of the vehicle, or on a small movable body such as an unmanned aerial vehicle (UAV), a so-called drone. Notably, the radar system is not limited to examples of modes of being mounted on a vehicle but can be fixed and used, for example, on a road or a building.

Applications to radar systems, communication systems and various monitoring systems including the antenna arrays are disclosed, for example, in U.S. Pat. No. 9,786,995. The disclosure of the relevant contents is incorporated into the specification of the present application by reference in its entirety. The antenna arrays of the present disclosure can be applied to applications disclosed in the relevant literature.

Notably, structures of connecting the microwave integrated circuit such as an MMIC to a waveguide, which can be used in combination of the antenna or an antenna array of the present application, are disclosed, for example, in U.S. patent application Ser. No. 15/996,795; U.S. patent application Ser. No. 16/022,893; U.S. patent application Ser. No. 16/145,491; U.S. patent application Ser. No. 16/170,172; U.S. patent application Ser. No. 16/234,749 and International Publication No. WO 2018/105513. The disclosures of the relevant literatures are incorporated into the specification of the present application by reference in their entireties.

The antenna elements and the antenna arrays according to example embodiments of the present disclosure can be used in all the technical fields that use antennas. For example, they can be used for various purposes of transmitting/receiving electromagnetic waves, for example, in a gigahertz band or a terahertz band. They can be preferably used for in-vehicle radar systems which particularly require downsizing, various monitoring systems, indoor positioning systems and wireless communication systems.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A method of manufacturing an antenna element, the method comprising:
forming a hollow by combining at least two molds that are movable relative to each other;
injecting a material in a fluid state into the hollow and solidifying the material to produce a molded article; and
separating the molded article from the at least two molds by pushing at least one reception surface provided at a specific site of the molded article using an ejector pin in one of the at least two molds; wherein
the antenna element includes:
a block-shaped or plate-shaped conductor including a conductive surface; and
an at least partially conductive first protrusion and a conductive second protrusion connected to the conductive surface and extending in a direction away from the conductive surface;
the conductor includes at least one first slot opening on the conductive surface, a center portion of the first slot extending in a first direction along the conductive surface;
the first protrusion and the second protrusion are aligned in a second direction which intersects the first direction and is along the conductive surface;
when the conductive surface is seen in plan view:
the center portion is located at a position interposed between the first protrusion and the second protrusion;
a distance between a center of the first protrusion and an edge of an opening of the first slot at the center portion is smaller than a distance between a tip surface of the first protrusion and the conductive surface; and
a distance between a center of the second protrusion and an edge of the opening of the first slot at the center portion is smaller than a distance between a tip surface of the second protrusion and the conductive surface; and
at least one first kind of reception surface included in the at least one reception surface is located on at least one of the tip surfaces of the first protrusion and the second protrusion.

2. The antenna element of claim 1, wherein
the first slot includes a pair of vertical portions extending in a direction intersecting the first direction;
the pair of vertical portions are connected by the center portion; and
the conductive surface includes at least one second kind of reception surface which is included in the at least one reception surface at a site at which a virtually elongated one of the center portions crosses.

3. The antenna element of claim 1, wherein
the first slot includes a pair of vertical portions extending in a direction intersecting the first direction;
the pair of vertical portions are connected by the center portion; and
at least the first protrusion includes, on its lateral surface, a bulge expanding toward the first slot and extending in a height direction of the first protrusion.

4. The antenna element of claim 1, wherein
at least the first protrusion includes, on its lateral surface, a bulge expanding toward the first slot and extending in a height direction of the first protrusion;
one end of the bulge reaches the tip surface to define a wider portion of the tip surface; and
at least a portion of the first kind of reception surface is provided in the wider portion.

5. The antenna element of claim 1, wherein
the first slot includes a pair of vertical portions extending in a direction intersecting the first direction;
the pair of vertical portions are connected by the center portion;
at least the first protrusion includes, on its lateral surface, a bulge expanding toward the first slot and extending in a height direction of the first protrusion;
one end of the bulge reaches the tip surface to define a wider portion of the tip surface; and
at least a portion of the first kind of reception surface is provided in the wider portion.

6. The antenna element of claim 1, wherein the at least one reception surface is convex or concave relative to its periphery.

7. The antenna element of claim 3, wherein the at least one reception surface is convex or concave relative to its periphery.

8. The antenna element of claim 1, wherein
the first kind of reception surface is convex or concave relative to its periphery; and
a difference in height between the first kind of reception surface and the periphery is smaller than a maximum value of a projection amount of the bulge.

9. The antenna element of claim 1, wherein
the first slot includes a pair of vertical portions extending in a direction intersecting the first direction;
the pair of vertical portions are connected by the center portion;
at least the first protrusion includes, on its lateral surface, a bulge expanding toward the first slot and extending in a height direction of the first protrusion;
the first kind of reception surface is convex or concave relative to its periphery; and
a difference in height between the first kind of reception surface and the periphery is smaller than a maximum value of a projection amount of the bulge.

10. The antenna element of claim 3, wherein
the conductive surface includes at least one second kind of reception surface which is included in the at least one reception surface at a site to which a virtually elongated one of the center portions crosses;
the first kind of reception surface is convex or concave relative to its periphery; and
a difference in height between the first kind of reception surface and the periphery is smaller than a maximum value of a projection amount of the bulge.

11. The antenna element of claim 1, wherein
at least the first protrusion includes a flat surface on the tip surface; and
when the conductive surface is seen in plan view, a center of gravity of the tip surface is within the first kind of reception surface.

12. The antenna element of claim 1, wherein
the first slot includes a pair of vertical portions extending in a direction intersecting the first direction;
the pair of vertical portions are connected by the center portion;
the conductive surface includes at least one second kind of reception surface which is included in the at least one reception surface at a site to which a virtually elongated one of the center portions crosses;
at least the first protrusion includes a flat surface on the tip surface; and
when the conductive surface is seen in plan view, a center of gravity of the tip surface is within the first kind of reception surface.

13. The antenna element of claim 1, wherein
at least the first protrusion includes, on its lateral surface, a bulge expanding toward the first slot and extending in a height direction of the first protrusion;
one end of the bulge reaches the tip surface to define a wider portion of the tip surface;
at least a portion of the first kind of reception surface is located in the wider portion;
at least the first protrusion includes a flat surface on the tip surface; and
when the conductive surface is seen in plan view, a center of gravity of the tip surface is within the first kind of reception surface.

14. An antenna array comprising:
the antenna element of claim 1; and
a conductive third protrusion connected to the conductive surface and extending in the direction away from the conductive surface; wherein
the conductor includes a second slot opening on the conductive surface, a center portion of the second slot extending in the first direction;
the first protrusion, the second protrusion, and the third protrusion are aligned in this order along the second direction;
when the conductive surface is seen in plan view:
the center portion of the second slot is located at a position interposed between the second protrusion and the third protrusion;
a distance between a circumferential surface of the second protrusion at its proximal end and an edge of an opening of the second slot at the center portion is smaller than a distance between the tip surface of the second protrusion and the conductive surface; and
a distance between a circumferential surface of the third protrusion at its proximal end and an edge of the opening of the second slot at the center portion is smaller than a distance between a tip of the third protrusion and the conductive surface;
the at least one first kind of reception surface includes at least two first kind of reception surfaces; and
the at least two first kind of reception surfaces are respectively located at least on the first protrusion and the third protrusion out of the first protrusion to the third protrusion.

15. An antenna array comprising:
the antenna element of claim 1; and
a conductive third protrusion connected to the conductive surface and extending in the direction away from the conductive surface; wherein
the first slot includes a pair of vertical portions extending in a direction intersecting the first direction;
the pair of vertical portions are connected by the center portion;
the conductive surface includes at least one second kind of reception surface which is included in the at least one reception surface at a site to which a virtually elongated one of the center portions crosses;
the conductor includes a second slot opening on the conductive surface, a center portion of the second slot extending in the first direction;
the first protrusion, the second protrusion, and the third protrusion are aligned in this order along the second direction;
when the conductive surface is seen in plan view:
the center portion of the second slot is located at a position interposed between the second protrusion and the third protrusion;
a distance between a circumferential surface of the second protrusion at its proximal end and an edge of an opening of the second slot at the center portion is smaller than a distance between the tip surface of the second protrusion and the conductive surface; and
a distance between a circumferential surface of the third protrusion at its proximal end and an edge of the opening of the second slot at the center portion is smaller than a distance between a tip of the third protrusion and the conductive surface;
the at least one first kind of reception surface includes at least two first kind of reception surfaces; and
the at least two first kind of reception surfaces are respectively located at least on the first protrusion and the third protrusion out of the first protrusion to the third protrusion.

16. An antenna array comprising:
the antenna element of claim 1; and
a conductive third protrusion connected to the conductive surface and extending in the direction away from the conductive surface; wherein
the conductor includes a second slot opening on the conductive surface, a center portion of the second slot extending in the first direction;
the first protrusion, the second protrusion, and the third protrusion are aligned in this order along the second direction;
at least the first protrusion includes, on its lateral surface, a bulge expanding toward the first slot and extending in a height direction of the first protrusion;
when the conductive surface is seen in plan view:
the center portion of the second slot is located at a position interposed between the second protrusion and the third protrusion;
a distance between a circumferential surface of the second protrusion at its proximal end and an edge of an opening of the second slot at the center portion is smaller than a distance between the tip surface of the second protrusion and the conductive surface; and
a distance between a circumferential surface of the third protrusion at its proximal end and an edge of the opening of the second slot at the center portion is smaller than a distance between a tip of the third protrusion and the conductive surface;
the at least one first kind of reception surface includes at least two first kind of reception surfaces; and
the at least two first kind of reception surfaces are respectively located at least on the first protrusion and the third protrusion out of the first protrusion to the third protrusion.

17. An antenna array comprising:
the antenna element of claim 1; and
a conductive third protrusion connected to the conductive surface and extending in the direction away from the conductive surface; wherein
the conductor includes a second slot opening on the conductive surface, a center portion of the second slot extending in the first direction;
the first protrusion, the second protrusion, and the third protrusion are aligned in this order along the second direction; when the conductive surface is seen in plan view:
the center portion of the second slot is located at a position interposed between the second protrusion and the third protrusion;
a distance between a circumferential surface of the second protrusion at its proximal end and an edge of an opening of the second slot at the center portion is smaller than a distance between the tip surface of the second protrusion and the conductive surface; and
a distance between a circumferential surface of the third protrusion at its proximal end and an edge of the opening of the second slot at the center portion is smaller than a distance between a tip of the third protrusion and the conductive surface;
the at least one first kind of reception surface includes at least two first kind of reception surfaces; and
the at least two first kind of reception surfaces are respectively located at least on the first protrusion and the third protrusion out of the first protrusion to the third protrusion.

18. An antenna array comprising:
the antenna element of claim 1; wherein
the conductor includes a third slot opening on the conductive surface, a center portion of the third slot extending in the first direction;
the third slot includes a pair of vertical portions extending in a direction intersecting the first direction;
the pair of vertical portions of the third slot are connected by the center portion of the third slot;
the first slot and the third slot are aligned in the first direction;
one of the pair of the vertical portions of the first slot and one of the pair of the vertical portions of the third slot are intervened by a wall that is a portion of the conductor; and
at least one reception surface includes at least one second kind of reception surface located on the wall.

19. An antenna array comprising:
the antenna element of claim 1; wherein
the conductor includes a third slot opening on the conductive surface, a center portion of the third slot extending in the first direction;
at least the first protrusion includes, on its lateral surface, a bulge expanding toward the first slot and extending in a height direction of the first protrusion;
the third slot includes a pair of vertical portions extending in a direction intersecting the first direction;
the pair of vertical portions of the third slot are connected by the center portion of the third slot;
the first slot and the third slot are aligned in the first direction;
one of the pair of the vertical portions of the first slot and one of the pair of the vertical portions of the third slot are separated by a wall that is a portion of the conductor; and
at least one reception surface includes at least one second kind of reception surface located on the wall.

20. An antenna array comprising:
the antenna element of claim 9; and
a conductive third protrusion connected to the conductive surface and extending in the direction away from the conductive surface; wherein
the conductor includes a second slot opening on the conductive surface, a center portion of the second slot extending in the first direction;
the conductor includes a third slot opening on the conductive surface, a center portion of the third slot extending in the first direction;
the first protrusion, the second protrusion, and the third protrusion are aligned in this order along the second direction;
the third slot includes a pair of vertical portions extending in a direction intersecting the first direction;
the pair of vertical portions of the third slot are connected by the center portion of the third slot;
the first slot and the third slot are aligned in the first direction;
one of the pair of the vertical portions of the first slot and one of the pair of the vertical portions of the third slot are separated by a wall that is a portion of the conductor;
at least one reception surface includes at least one second kind of reception surface located on the wall;
when the conductive surface is seen in plan view:
the center portion of the second slot is located at a position interposed between the second protrusion and the third protrusion;
a distance between a circumferential surface of the second protrusion at its proximal end and an edge of an opening of the second slot at the center portion is smaller than a distance between the tip surface of the second protrusion and the conductive surface; and
a distance between a circumferential surface of the third protrusion at its proximal end and an edge of the opening of the second slot at the center portion is smaller than a distance between a tip of the third protrusion and the conductive surface;
the at least one first kind of reception surface includes at least two first kind of reception surfaces; and
the at least two first kind of reception surfaces are respectively located at least on the first protrusion and the third protrusion out of the first protrusion to the third protrusion.

21. An antenna array comprising:
the antenna element of claim 16; and
the conductor includes a third slot opening on the conductive surface, a center portion of the third slot extending in the first direction; wherein
the third slot includes a pair of vertical portions extending in a direction intersecting the first direction;
the pair of vertical portions of the third slot are connected by the center portion of the third slot;
the first slot and the third slot are aligned in the first direction;
one of the pair of the vertical portions of the first slot and one of the pair of the vertical portions of the third slot are separated by a wall that is a portion of the conductor; and
at least one reception surface includes at least one second kind of reception surface located on the wall.

22. A radar apparatus comprising:
the antenna array of claim 14; and
a microwave integrated circuit connected to the antenna array.

23. A radar apparatus comprising:
an antenna array including the antenna element of claim 1; and
a microwave integrated circuit connected to the antenna array; wherein
the conductor includes a third slot opening on the conductive surface, a center portion of the third slot extending in the first direction; wherein
the third slot includes a pair of vertical portions extending in a direction intersecting the first direction;
the pair of vertical portions of the third slot are connected by the center portion of the third slot;
the first slot and the third slot are aligned in the first direction;
one of the pair of the vertical portions of the first slot and one of the pair of the vertical portions of the third slot are intervened by a wall, the wall being a portion of the conductor; and
at least one reception surface includes at least one second kind of reception surface, the at least one second kind of reception surface being located on the wall.

24. A radar apparatus comprising:
an antenna array including the antenna element of claim 1; and
a microwave integrated circuit connected to the antenna array; wherein
the conductor includes a third slot opening on the conductive surface, a center portion of the third slot extending in the first direction; wherein
at least the first protrusion includes, on its lateral surface, a bulge expanding toward the first slot and extending in a height direction of the first protrusion;
the third slot includes a pair of vertical portions extending in a direction intersecting the first direction;
the pair of vertical portions of the third slot are connected by the center portion of the third slot;
the first slot and the third slot are aligned in the first direction;
one of the pair of the vertical portions of the first slot and one of the pair of the vertical portions of the third slot are intervened by a wall, the wall being a portion of the conductor; and
at least one reception surface includes at least one second kind of reception surface, the at least one second kind of reception surface being located on the wall.

25. A radar apparatus comprising:
an antenna array including the antenna element of claim 4;
a conductive third protrusion connected to the conductive surface and extending in the direction away from the conductive surface; and
a microwave integrated circuit connected to the antenna array; wherein
the conductor includes a second slot opening on the conductive surface, a center portion of the second slot extending in the first direction;
the first protrusion, the second protrusion, and the third protrusion are aligned in this order along the second direction;
when the conductive surface is seen in plan view:
the center portion of the second slot is located at a position interposed between the second protrusion and the third protrusion;
a distance between a circumferential surface of the second protrusion at its proximal end and an edge of an opening of the second slot at the center portion is smaller than a distance between the tip surface of the second protrusion and the conductive surface; and
a distance between a circumferential surface of the third protrusion at its proximal end and an edge of the opening of the second slot at the center portion is smaller than a distance between a tip of the third protrusion and the conductive surface;
the at least one first kind of reception surface includes at least two first kind of reception surfaces; and
the at least two first kind of reception surfaces are respectively located at least on the first protrusion and the third protrusion out of the first protrusion to the third protrusion.
